(19) United States
(12) Patent Application Publication
(10) Pub. No.: US 2013/0118218 A1
(43) Pub. Date: May 16, 2013

(54) LOCK ASSEMBLY HAVING OUTER AND INNER LOCK UNITS

(71) Applicant: Tong Lung Metal Industry Co., Ltd., Chia-Yi City (TW)

(72) Inventors: Ming-Shyang CHIOU, Chiayi City (TW); Ching-Chuan KUO, Chiayi County (TW); Chia-Min SUN, Chiayi City (TW); Yu-Ting HUANG, Chiayi City (TW)

(73) Assignee: TONG LUNG METAL INDUSTRY CO., LTD., Chia-Yi City (TW)

(21) Appl. No.: 13/671,826

(22) Filed: Nov. 8, 2012

(30) Foreign Application Priority Data
Nov. 11, 2011 (TW) 100221244
Apr. 9, 2012 (TW) 101206343

(51) Int. Cl. E05B 65/00; E05B 21/06

(52) U.S. Cl. 70/91

(57) ABSTRACT

In a lock assembly, a spindle that is inserted into a rectangular latch operating tube is arranged to be rotatable from an unlocked state to a first locked state, and to be movable axially from the unlocked state to a second locked state. The spindle is connected to a key-operated lock of an outer lock unit and to an operator of an inner lock unit. The key-operated lock is rotatable to operate the spindle to the first lock state from the unlocked state, and the operator is pressable to move the spindle to the second locked state from the unlocked state.

### CROSS-REFERENCE TO RELATED APPLICATION

This application claims priority of Taiwanese Patent Application Nos. 100221244 filed on Nov. 11, 2011 and 101206343 filed on Apr. 9, 2012.

### BACKGROUND OF THE INVENTION

1. Field of the Invention

The invention relates to a lock assembly, more particularly to a cylinder lock assembly having an inner lock unit which can be pressed to perform a locking operation.

2. Description of the Related Art

A cylinder lock assembly typically includes an inner lock unit provided with a push button or rotary button for operating a locking spindle that passes through a rectangular latch operating tube. When the locking spindle is operated through the push or rotary button, the cylinder lock assembly can be placed in a locked state. However, the rotation of the rotary button is inconvenient for handicapped persons.

### SUMMARY OF THE INVENTION

An object of the present invention is to provide a cylinder lock assembly that has a simplified construction and that has a spindle, which can be pressed to perform a locking operation.

According to one aspect of the invention, a cylinder lock assembly comprises a latch unit, an outer handle, a latch operating tube, a spindle, a drive tube-retainer, a key-operated lock, and an inner lock unit. The outer drive tube is connected to the outer handle. The latch operating tube is connected to the latch unit, and has an enlarged end portion extending into the outer drive tube oppositely of the outer handle. The spindle extends axially through the latch operating tube, and has an end portion that extends through the enlarged end portion. The spindle is rotatable from an unlocked state to a first locked state, and is movable axially from the unlocked state to a second locked state. The drive tube-retainer prevents the outer drive tube from rotating when the spindle is in the first or second locked state. The key-operated lock is connected to the end portion of the spindle and is rotatable to operate the spindle to move to the first lock state from the unlocked state. The inner lock unit includes an operator that is connected to another end portion of the spindle and that is pressable to move the spindle to the second locked state from the unlocked state.

According to another aspect of the invention, a cylinder lock assembly comprises a latch unit, a rose disc, an outer handle, a latch operating tube, a spindle, an unlocking member, and an inner lock unit. The rose disc has a retaining recess. The outer drive tube is connected to the outer handle inside the rose disc and has an axially extending aperture. The latch operating tube is connected to the latch unit, and has an enlarged end portion extends into the outer drive tube oppositely of the outer handle. The spindle extends axially through the latch operating tube, and has an end portion that extends through the enlarged end portion. The spindle is movable between a locked state and an unlocked state. The unlocking member is connected to the enlarged end portion of the latch operating tube and engages the end portion of the spindle. The spindle is driven by the unlocking member to rotate from the locked state to the unlocked state when the latch operating tube is rotated. The inner lock unit includes an operator that is connected to another end portion of the spindle, and that is operable to move the spindle to the locked state from the unlocked state.

According to still another aspect of the invention, a cylinder lock assembly comprises a latch unit, a rose disc, an outer handle, a latch operating tube, a spindle, a cam member, a key-operated lock, and an inner lock unit. The rose disc has a retaining recess. The outer drive tube is connected to the outer handle inside the rose disc and has an axially extending aperture. The latch operating tube is connected to the latch unit, and has an enlarged end portion extending into the outer drive tube oppositely of the outer handle. The spindle extends axially through the latch operating tube, and has an end portion that extends through the enlarged end portion, and a lug projecting radially and outwardly from the end portion. The spindle is rotatable from an unlocked state to a first locked state, and is movable axially from the unlocked state to a second locked state. The cam member is disposed around the end portion of the spindle and includes a cam face to abut against the lug of the spindle, and a locking tongue projecting radially and outwardly from an outer periphery of the cam member to extend through the aperture of the outer drive tube. The cam face has a shallow surface, a deep surface and a slanting surface extending between the shallow and deep surfaces. A key-operated lock has a rotatable plug, and a coupler connected to the plug. The coupler has wide and narrow coupling slots that are aligned and intercommunicated axially. The end portion of the spindle has a terminating end. The terminating end is inserted into the wide coupling slot when the spindle is in the unlocked state and the first locked state and extends through the wide coupling slot and into the narrow coupling slot when the spindle is pressed to the second locked state. The inner lock unit includes an operator that is connected to another end portion of the spindle and that is pressable to move the spindle to the second locked state from the unlocked state.

The locking tongue is movable axially along the aperture to engage or disengage the retaining recess when the spindle is moved to actuate the lug to move the cam face. The locking tongue engages the retaining recess when the spindle is moved from the unlocked state to the second locked state.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a cylinder lock assembly according to a first preferred embodiment of the present invention;

FIG. 2 is another exploded perspective view showing the cylinder lock assembly in more detail;

FIG. 3 is a perspective view showing a latch operating tube of the cylinder lock assembly;

FIG. 4 is a fragmentary perspective view showing a spindle of the cylinder lock assembly;

FIG. 5 is a perspective view showing a locking plate of the cylinder lock assembly;

FIG. 6 is a perspective view showing a key-operated lock of the cylinder lock assembly;

FIG. 7 is a sectional view taken along line 7-7 of FIG. 6;

FIG. 8 is a perspective view of a cam member of the cylinder lock assembly;

FIG. 9 is a perspective view of an unlocking member of the cylinder lock assembly;

FIG. 10 is a fragmentary longitudinal sectional view of the cylinder lock assembly, illustrating the spindle in an unlocked state;

FIG. 11 is another fragmentary longitudinal sectional view illustrating the spindle in the unlocked state;

FIG. 12 is the same view as FIG. 10 but showing the spindle that is pressed to move to a second locked state;

FIG. 13 is the same view as FIG. 11 but showing the spindle that is pressed;

FIG. 14 is a transverse sectional view illustrating the spindle and a locking plate both of which have not been rotated relative to the latch operating tube;

FIG. 15 is the same view as FIG. 14 but illustrating the spindle and the locking plate both of which are rotated relative to the latch operating tube;

FIG. 16 is the same view as FIG. 10 but showing that the spindle has been rotated to move to a first locked state;

FIG. 17 is the same view as FIG. 11 but showing that the spindle has been rotated to move to the first locked state;

FIG. 18 is a transverse sectional view showing the spindle, the latch operating tube and an unlocking member, all of which have not been rotated;

FIG. 19 is the same view as FIG. 18 but showing the spindle, the latch operating tube and the unlocking member, all of which have been rotated;

FIG. 20 is a perspective exploded view illustrating different modifications for the key-operated lock of the cylinder lock assembly;

FIG. 21 is an exploded perspective view of a fourth preferred embodiment of the present invention;

FIG. 22 is a fragmentary perspective view showing a spindle of the fourth embodiment;

FIG. 23 is a perspective view showing a locking plate of the fourth embodiment;

FIG. 24 is a perspective view showing a coupler of the fourth embodiment;

FIG. 25 is a sectional view taken along line 25-25 of FIG. 24;

FIG. 26 is a perspective view of an unlocking plate of the fourth embodiment;

FIG. 27 is a fragmentary longitudinal sectional view of the fourth embodiment, illustrating the spindle in an unlocked state;

FIG. 28 is another fragmentary longitudinal sectional view illustrating the spindle of the fourth embodiment in the unlocked state;

FIG. 29 is the same view as FIG. 27 but showing the spindle that is pressed to move to a second locked state;

FIG. 30 is the same view as FIG. 28 but showing the spindle that is pressed;

FIG. 31 is the same view as FIG. 27 but showing that the spindle is rotated to move to a first locked state;

FIG. 32 is the same view as FIG. 28 but showing the spindle in the first locked state; and

FIG. 33 is a perspective view of the latch operating tube of the fourth embodiment.

### DETAILED DESCRIPTION OF THE PREFERRED EMBODIMENTS

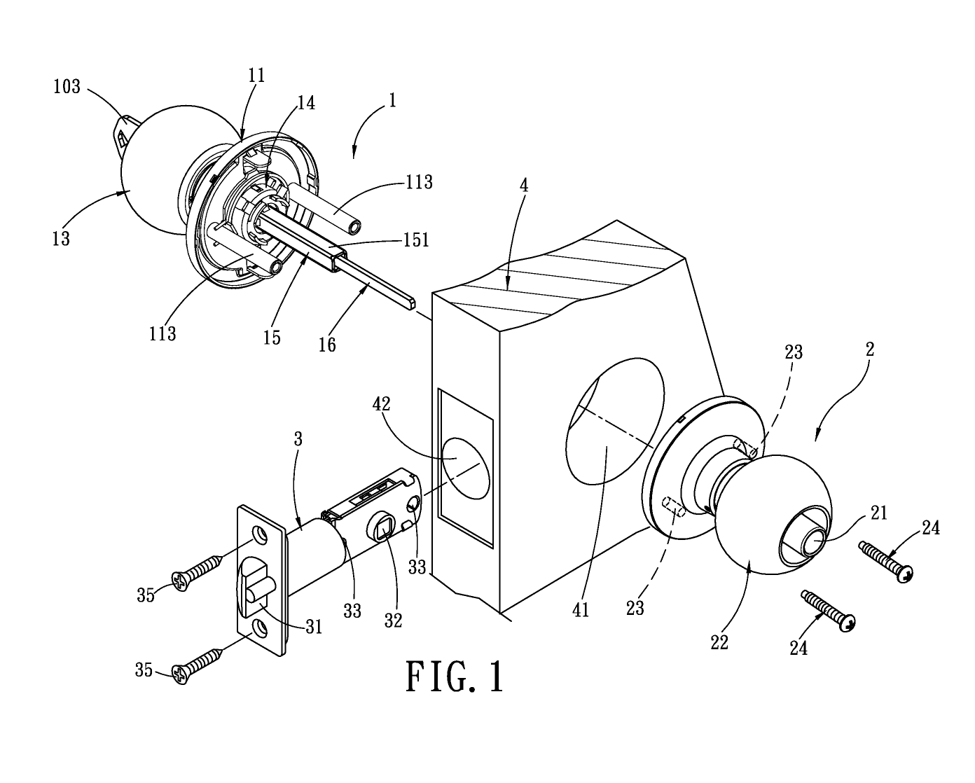

Referring to FIG. 1, a cylinder lock assembly according to a first preferred embodiment of the present invention is mounted on a door panel 4, and includes an outer lock unit, an inner lock unit 2 and a latch unit 3. The outer and inner lock units 1, 2 are connected to the latch unit 3 to operate the same.

The inner lock unit 2 includes an inner handle 22 receiving the operator 21. As the inner lock unit 2 is well known in the art, the details thereof are omitted hereinafter.

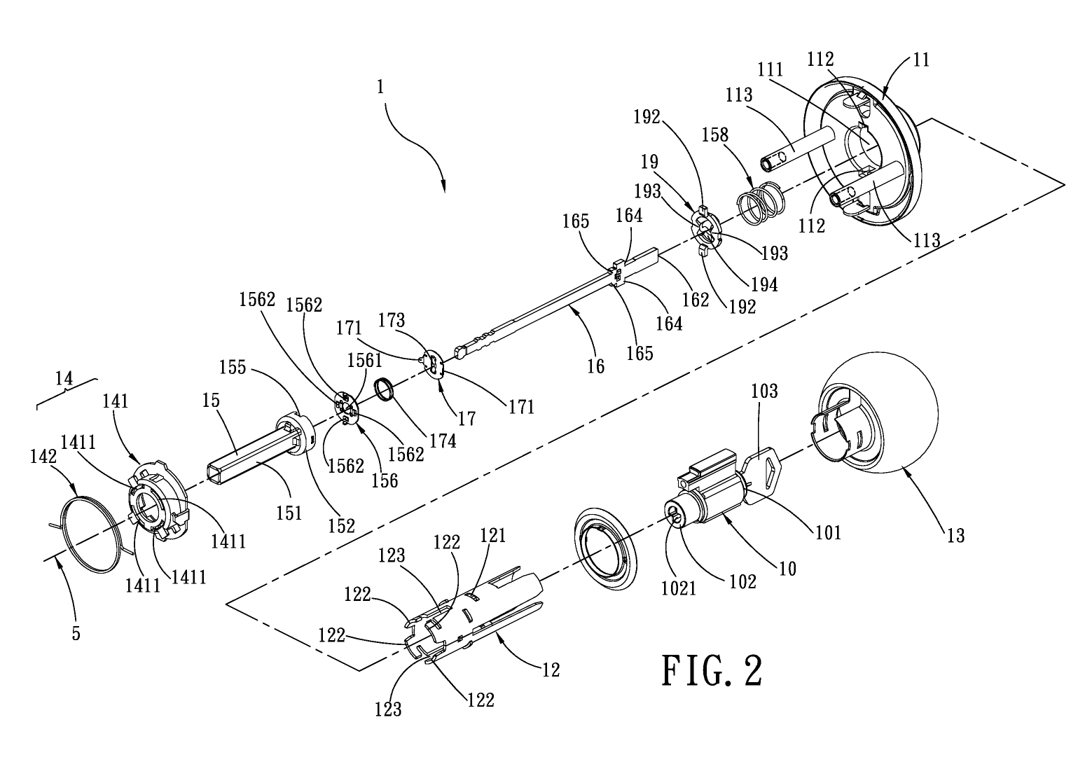

Referring to FIGS. 2 to 10, the outer lock unit 1 includes the following components:

A rose disc 11 has a central hole 111, two diametrically opposite retaining recesses 112, and two internally threaded hollow mounting posts 113.

An outer drive tube 12 is connected to the rose disc 11 in the central hole 111. A retention member 121 is disposed in the outer drive tube 12 to retain the outer drive tube 12 in an outer handle 13. A key-operated lock 10 is disposed partially in the outer drive tube 12 and partially in the outer handle 13. The outer drive tube 12 has four fingers 122 extending axially from one end thereof into four slots 1411 of a torsional returning mechanism 14 that has a torsion spring 142 for returning the outer handle 13 after the outer handle 13 is rotated. The outer drive tube 12 further has two diametrically opposite elongated apertures 123 proximate to the fingers 122.

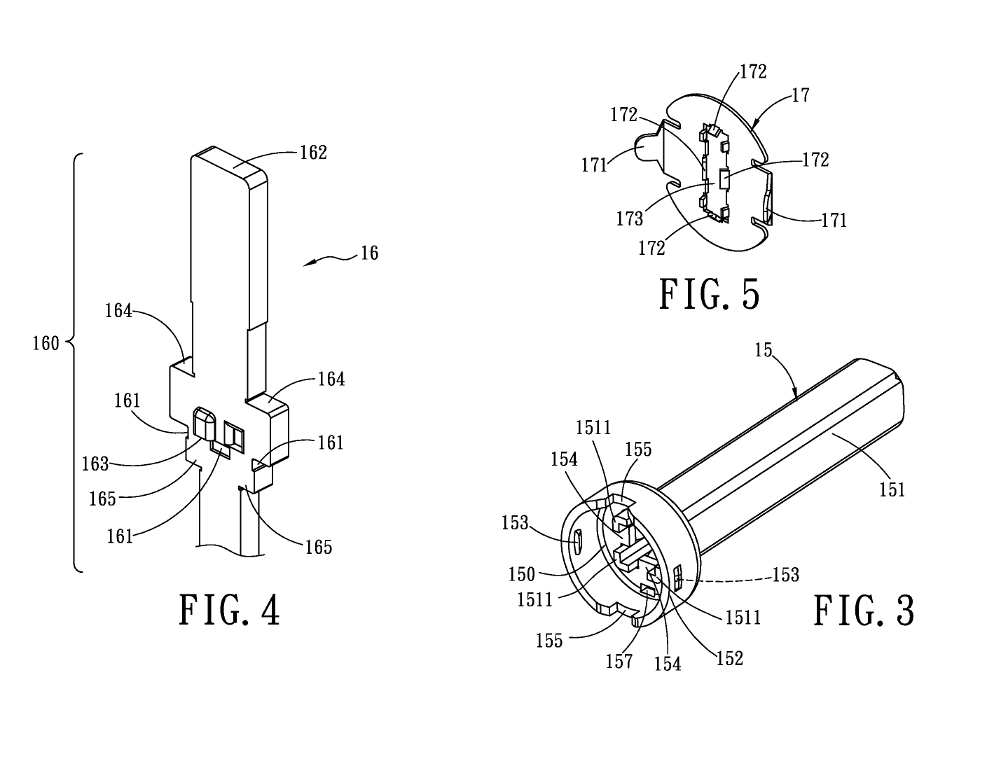

A latch operating tube 15 has a rectangular tube 151, a substantially cylindrical enlarged end portion 152, and a shoulder portion 150 formed between the rectangular tube 151 and the enlarged end portion 152. As best shown in FIG. 3, the enlarged end portion 152 has two protrusions 153 projecting inwardly and radially from an inner wall surface of the enlarged end portion 152, and two notches 155 indented axially from a peripheral edge of the enlarged end portion 152. Each protrusion 153 is spaced from each notch 155 by an angle of about 90 degrees. The rectangular tube 151 has four corner elements 1511 (only three are shown) extending into the enlarged end portion 152 and fixed in the shoulder portion 150. Four gaps 154 (only two are shown) are formed between the corner elements 1511. Two holes 157 are formed in the shoulder portion 150.

A spindle 16 is inserted into the rectangular tube 151 and has an end portion 160 extending through the enlarged end portion 152 of the latch operating tube 15. As best shown in FIG. 4, The end portion 160 of the spindle 16 has a terminating end 162 for extending outwardly of the enlarged end portion 152, two opposite radially projecting lugs 164, two opposite radially projecting ear members 165 proximate to the lugs 164, four interlocking grooves 161 (only three are shown in the figure) formed between the lugs 164 and the ear members 165, and two stop elements 163. The terminating end 162 is connected to the key-operated lock 10. The inner end of the spindle 16 is connected to the operator 21 of the inner lock unit 2. The spindle 16 is rotatable from an unlocked state (i.e., the operator 21 is neither pressed nor rotated) to a first locked state (i.e., the operator 21 has been rotated), and is also movable axially from the unlocked state to a second locked state (i.e., the operator 21 has been pressed).

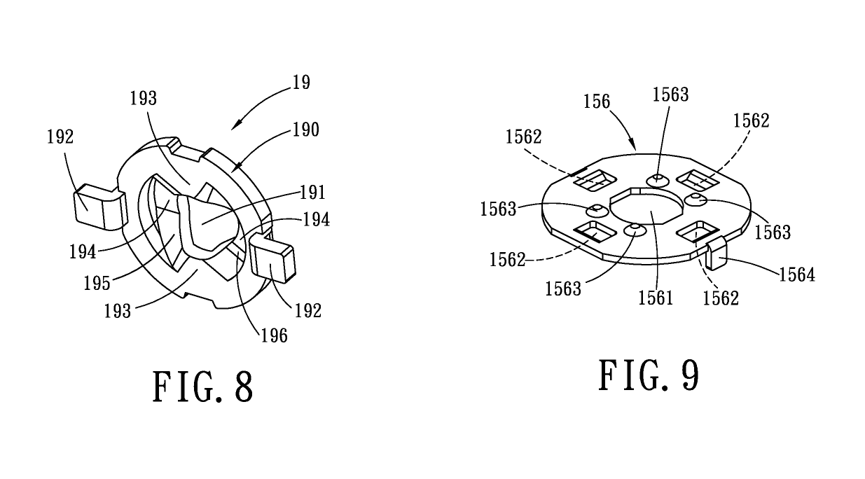

A cam member 19 is used as a drive tube-retainer to prevent the outer drive tube 12 from rotating when the spindle 16 is in the first or second locked state. As best shown in FIG. 8, the cam member 19 includes a central through hole 191 sleeved around the spindle 16, and a cam face 190 to contact the lugs 164 of the spindle 16. The cam face 190 surrounds the central through hole 191 and includes two shallow surfaces 193, two deep surfaces 194, and two slanting surfaces 195 and two actuating surfaces 196 formed between the shallow and deep surfaces 193, 194. Two diametrically opposite locking tongues 192 project radially from an outer periphery of the cam member 19.

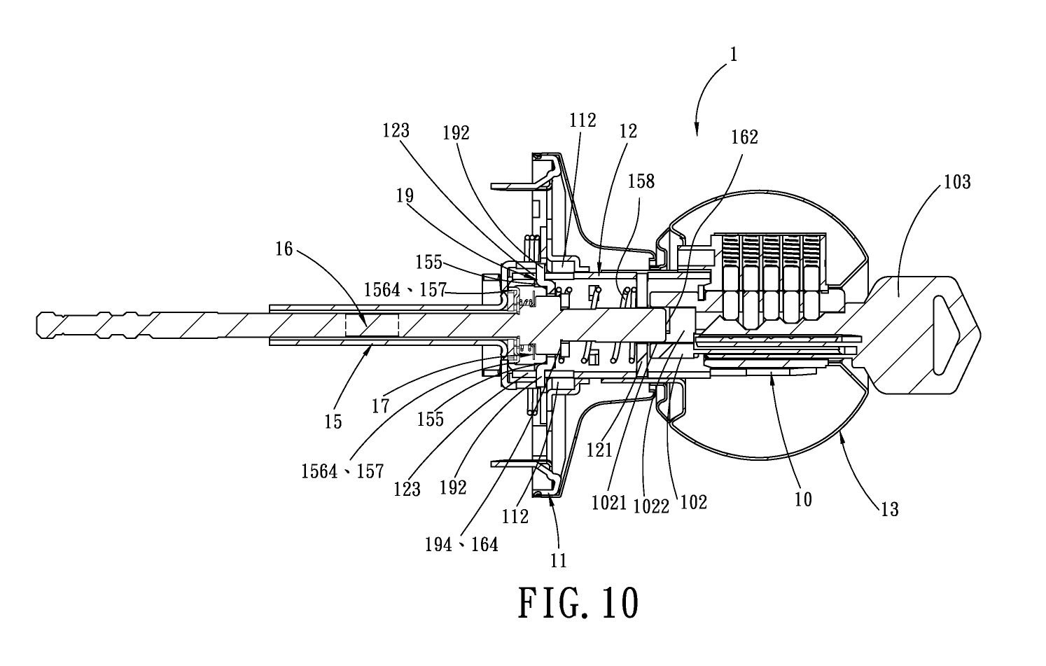

A first spring 158 is disposed between the cam member 19 and the retention member 121 within the outer drive tube 12 as best shown in FIG. 10. One end of the first spring 158 is retained on the cam member 19. Another end of the first spring 158 is retained on the retention member 121, thereby biasing the cam member 19 to move to the lugs 164 of the spindle 16.

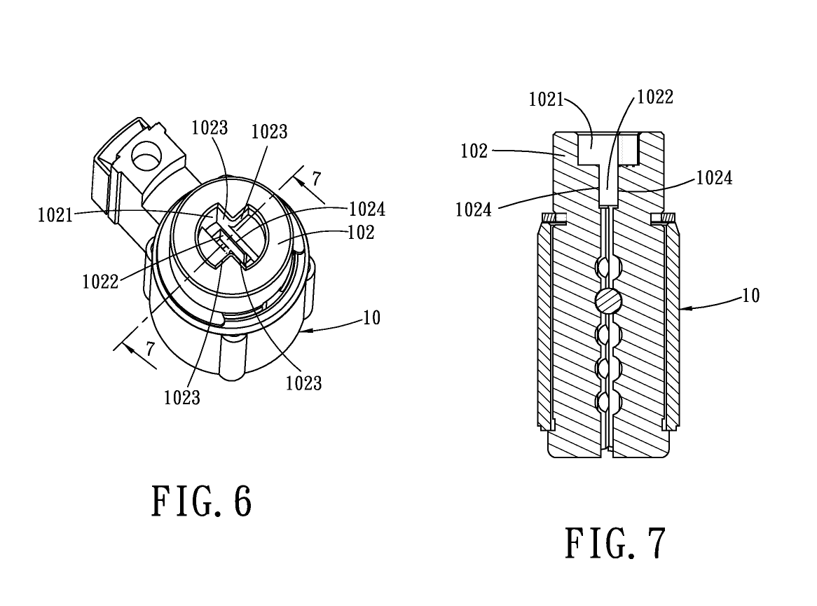

The key operated lock 10 includes a plug 101 having a tail end formed with a coupler 102 that includes wide and narrow coupling slots 1021, 1022, which are aligned and intercommunicated axially as best shown in FIGS. 6 and 7. In this embodiment, the wide coupling slot 1021 has a substantially figure eight-shape in cross section, and the small coupling slot 1022 has a narrow rectangular cross section. Four push edges 1023 are formed around the wide coupling slot 1021, and two drive edges 1024 are formed around the narrow coupling slot 1022. When the spindle 16 is in the unlocked state, the terminating end 162 of the spindle 16 is inserted into the wide coupling slot 1021, and the lugs 164 are in abutment with the deep surfaces 194 of the cam member 19. When the spindle 16 is in the second locked state, the terminating end 162 extends into the small coupling slot 1022, and the lugs 164 are still in abutment with the deep surfaces 194. When the spindle 16 is in the first locked state, the terminating end 162 is in the wide coupling slot 1021, and the lugs 164 are in abutment with the shallow surfaces 193. When the plug 101 is rotated by a key 103, the push edges 1023 of the wide coupling slot 1021 or the drive edges 1024 of the narrow coupling slot 1022 will drive rotation of the spindle 16.

A locking plate 17 is attached fixedly to the spindle 16 inside the enlarged end portion 152 of the spindle 16, and is used to prevent the spindle 16 from moving to the unlocked state from the second locked state when the spindle 16 is in the second locked state. As best shown in FIG. 5, the locking plate 17 includes a central hole 173, two diametrically opposite locking parts 171, and four resilient bent tabs 172 projecting inclinedly in proximity to the central hole 173. When the central hole 173 of the locking plate 17 is sleeved around the spindle 16, the bent tabs 172 interlock with the respective interlocking grooves 161 so that the locking Plate 17 is prevented from moving relative to the spindle 16. At the same time, the locking plate 17 abuts against the stop elements 163 of the spindle 16 so that it is stabilized and prevented from becoming loosened relative to the spindle 16. The locking parts 171 are engageable with the protrusions 153 of the latch operating tube 15. Details of the locking parts 171 and the protrusions 153 are disclosed in co-pending U.S. patent application Ser. No. 13/484,562, which is incorporated herein by reference.

An unlocking member includes an unlocking plate 156 that is disposed inside the enlarged end portion 152 of the latch operating tube 15 and that is used to drive rotation of the spindle 16 to the unlocked state from the first locked state when the latch operating tube 15 is rotated. As best shown in FIG. 9, the unlocking plate 156 includes a central hole 1561 for extension of the spindle 16, and four tabs 1562 protruding from one side of the unlocking plate 156 to respectively engage the gaps 154 disposed on the shoulder portion 150 of the latch operating tube 15. The unlocking plate 156 is therefore connected to the shoulder portion 150. The unlocking plate 156 further includes two diametrically opposite prongs 1564 projecting into the respective holes 157 formed in the shoulder portion 150. The unlocking plate 156 further includes an engagement surface that is formed on the unlocking plate 156 oppositely of the surface of the shoulder portion 150 and that has four studs 1563 protruding axially of the spindle 16 to engage and clamp the ear members 165 of the spindle 16. While the unlocking plate 156 is a separate piece from the latch operating tube 15, it may alternatively be formed as one piece with the latch operating tube 15 by using an integral forming method.

A second spring 174 is disposed between the unlocking plate 156 and the locking plate 17. One end of the second spring 174 is retained on the unlocking plate 156, and another end thereof is retained on the locking plate 17.

Note that the locking plate 17 is disposed between the unlocking plate 156, which is fixed to the shoulder portion 150, and the cam member 19, which is adjacent to the peripheral edge of the enlarged end portion 152. The ear members 165 and the lug members 164 are aligned axially with each other between the cam member 19 and the locking plate 17. The locking plate 17 is positioned to the spindle 16 between the lug members 164 and the ear members 165.

Referring once again to FIG. 1, a latch unit 3 is secured in a mounting hole 42 formed in one edge of the door panel 4 by means of screws 35. The latch unit 3 has a rectangular hole 32 and two circular holes 33. The latch operating tube 15 is placed in another hole 41 in the door panel 4, and is extended through the rectangular hole 32 in the latch unit 3 for connection with the inner lock unit 2. A latch member 31 of the latch unit 3 may be actuated by operating the latch operating tube 15. The mounting posts 113 are inserted through the respective circular holes 33 in the latch unit 3 and are connected to the inner lock unit 2 through the use of two screws 24 disposed in holes 23 of the inner lock unit 2.

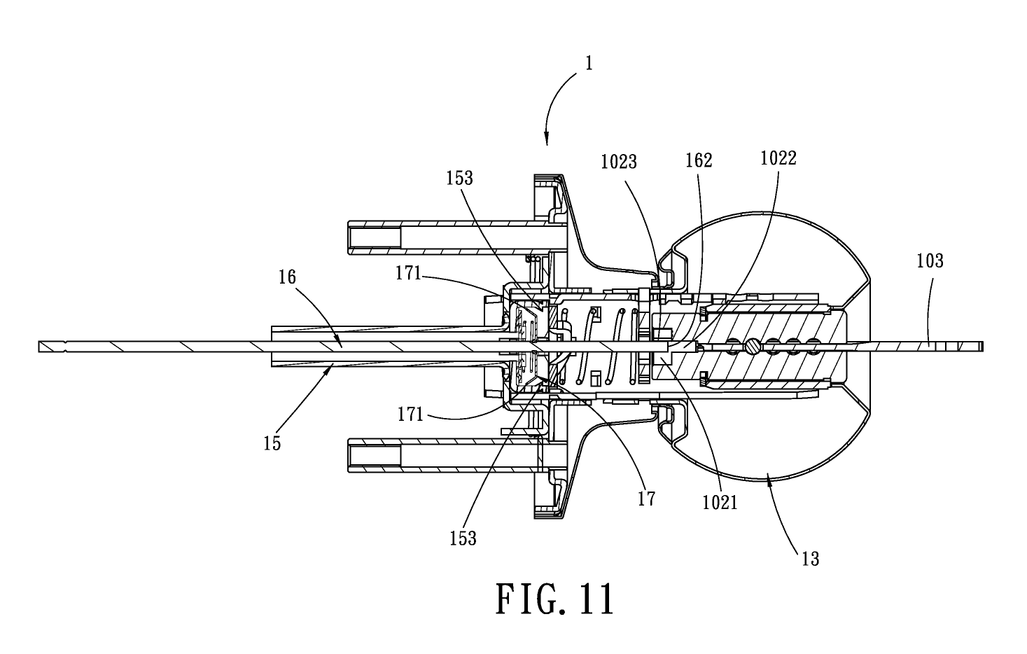

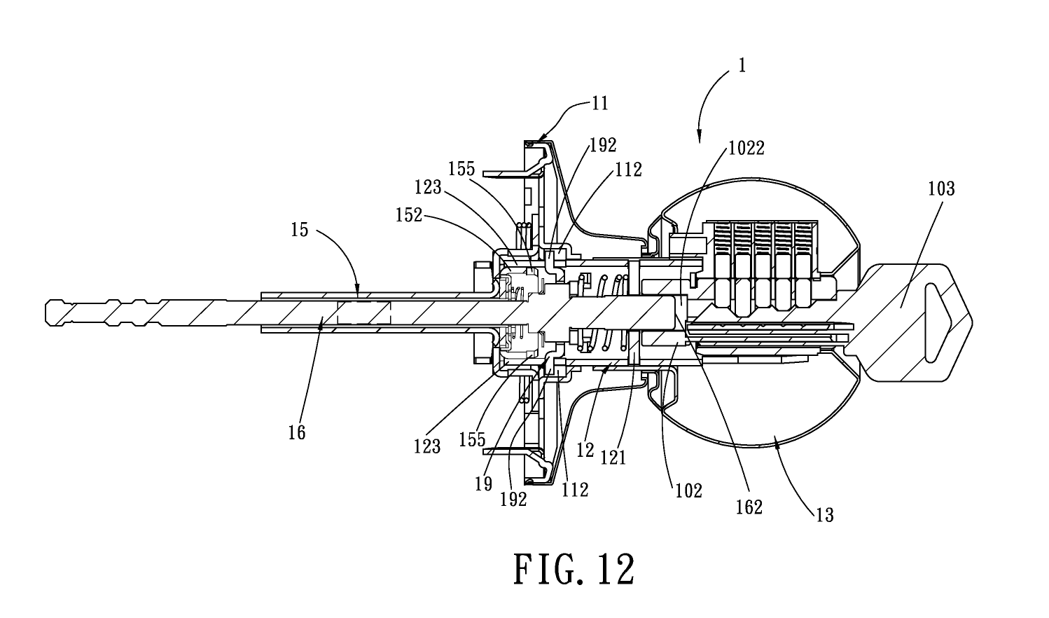

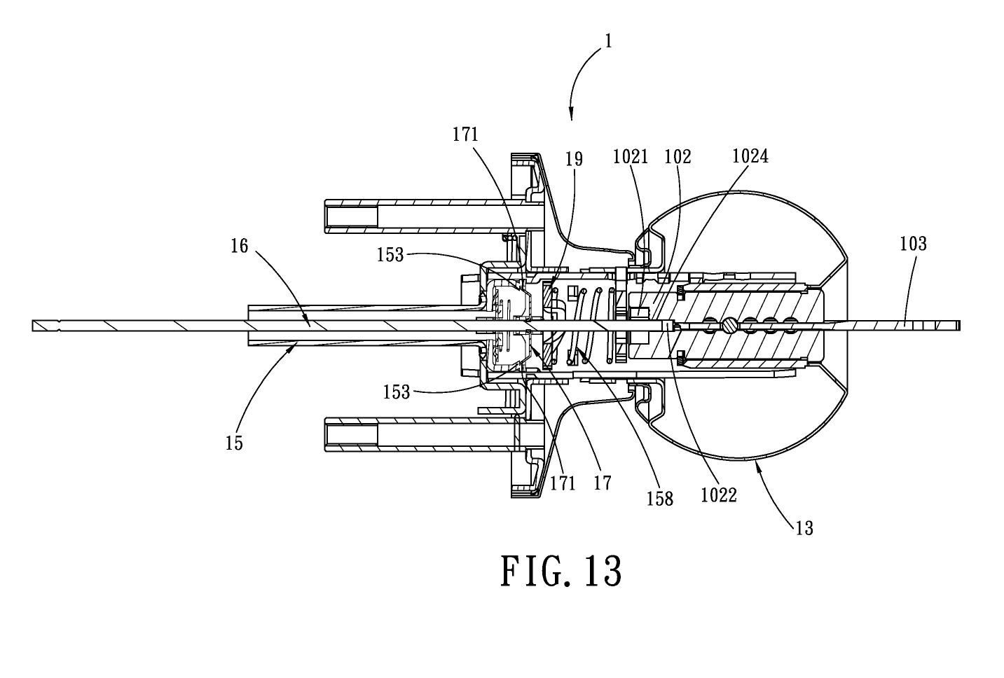

Referring to FIGS. 1 and 10-13, when the operator 21 of the inner lock unit 2 is pressed, the spindle 16 is moved from the unlocked state (FIGS. 10 & 11) to the second locked state (FIGS. 12 & 13). The spindle 16 thus pushes the cam member 19 to move it from a position shown in FIGS. 10 and 11 to another position shown in FIGS. 12 and 13. At this state, the terminating end 162 of the spindle 16 extends into the small coupling slot 1022 of the connecting end 102 of the plug 101 from the wide coupling slot 1021. At the same time, the locking parts 171 of the locking plate 17 move from their positions shown in FIG. 11 (where the locking parts 171 do not engage the protrusions 153) to their positions shown in FIG. 13 (where the locking parts 171 engage the respective protrusions 153) by sliding over inclined surfaces of the respective protrusions 153 so as to engage the respective protrusions 153. As the locking tongues 192 of the cam member 19 also slide within the respective apertures 123 of the outer drive tube 12, the locking tongues 192 move from the respective notches 155 (see FIG. 10) of the latch operating tube 15 to the respective retaining recesses 112 (see FIG. 12) in the rose disc 11. Accordingly, the outer drive tube 12 is limited from a rotational movement relative to the rose disc 11, and the outer handle 13 cannot be rotated. The entire cylinder lock assembly is therefore placed in a locked state.

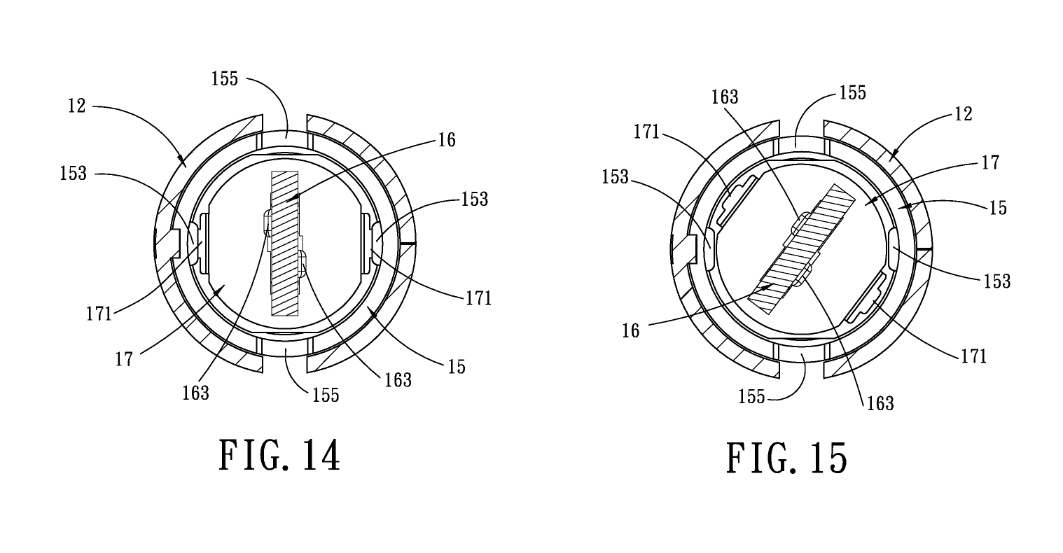

Referring back to FIGS. 1 to 15, the cylinder lock assembly can be unlocked by rotating the inner handle 22 of the inner lock unit 2, or by inserting a key 103 into the key-operated lock 10 of the outer lock unit 1. When the inner handle 22 is rotated to unlock the cylinder lock assembly, the latch operating tube 15 is rotated relative to the spindle 16 so that the protrusions 153 of the latch operating tube 15 move angularly away from the respective locking parts 171 from their positions shown in FIG. 14. At this state, the spindle 16 is allowed to move from its second locked state (FIGS. 12 & 13) to its unlocked state (FIGS. 10 & 11) by the action of the first spring 158. The cam member 19 is biased by the first spring 158 to move from the position shown in FIGS. 12 and 13 to the position shown in FIGS. 10 and 11. Accordingly, the locking tongues 192 of the cam member 19 slide along the respective apertures 123 in the outer drive tube 12 and move from the respective retaining recesses 112 in the rose disc 11 to the circumferential edge of the enlarged end portion 152 of the latch operating tube 15. When the inner handle 22 is returned to its home position by the returning action of a returning mechanism (not shown) of the inner lock unit 2, the locking tongues 192 return to the respective notches 155 in the latch operating tube 15. Because the locking tongues 192 move away from the respective recess 112 in the rose disc 11, the outer handle 13 can be rotated, and the cylinder lock assembly can be placed in an unlocked state.

When the key 103 is used to unlock the cylinder lock assembly by rotating the plug 101, because the terminating end 162 of the spindle 16 extends into the narrow coupling slot 1022 of the coupler 102 of the plug 101, the drive edges 1024 of the narrow coupling slot 1022 will drive the spindle 16 so that the spindle 16 is rotated and the locking parts 171 of the locking plate 17 are moved away from the respective protrusions 153 and from their positions shown in FIG. 14 to their positions shown in FIG. 15. Accordingly, the locking tongues 192 of the cam member 19 are biased by the first spring 158 to move along the respective apertures 123 and from their positions shown in FIGS. 12, 13 to another positions shown in FIGS. 10 and 11, where the locking tongues 192 disengage from the respective retaining recess 112 to place the cylinder lock assembly in the unlocked state.

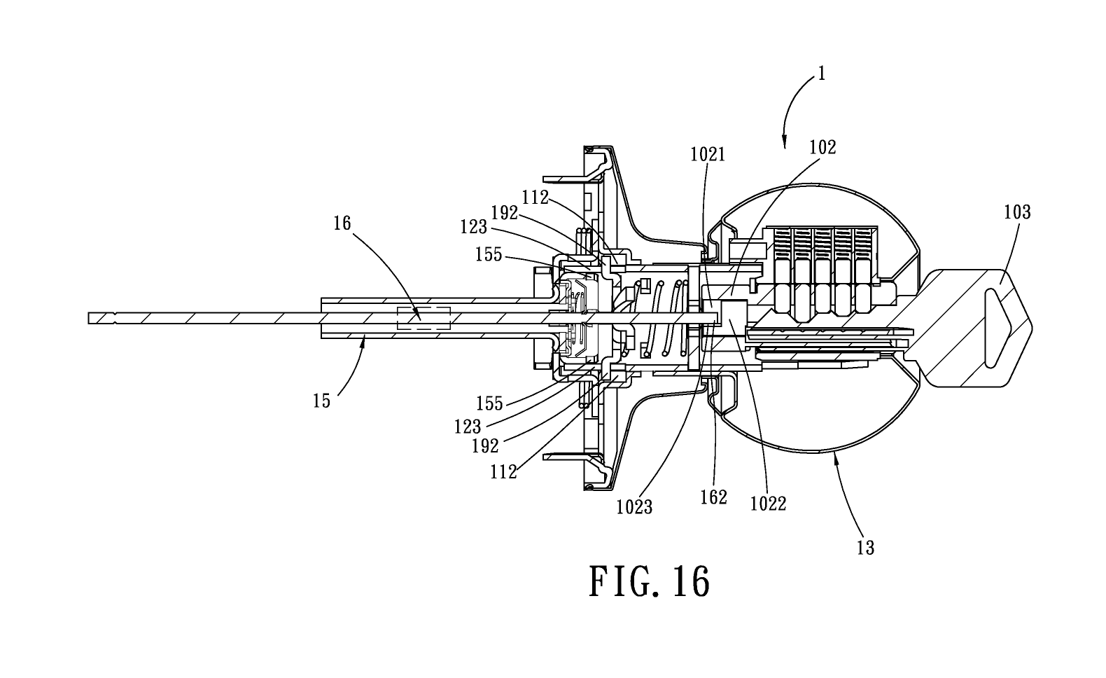

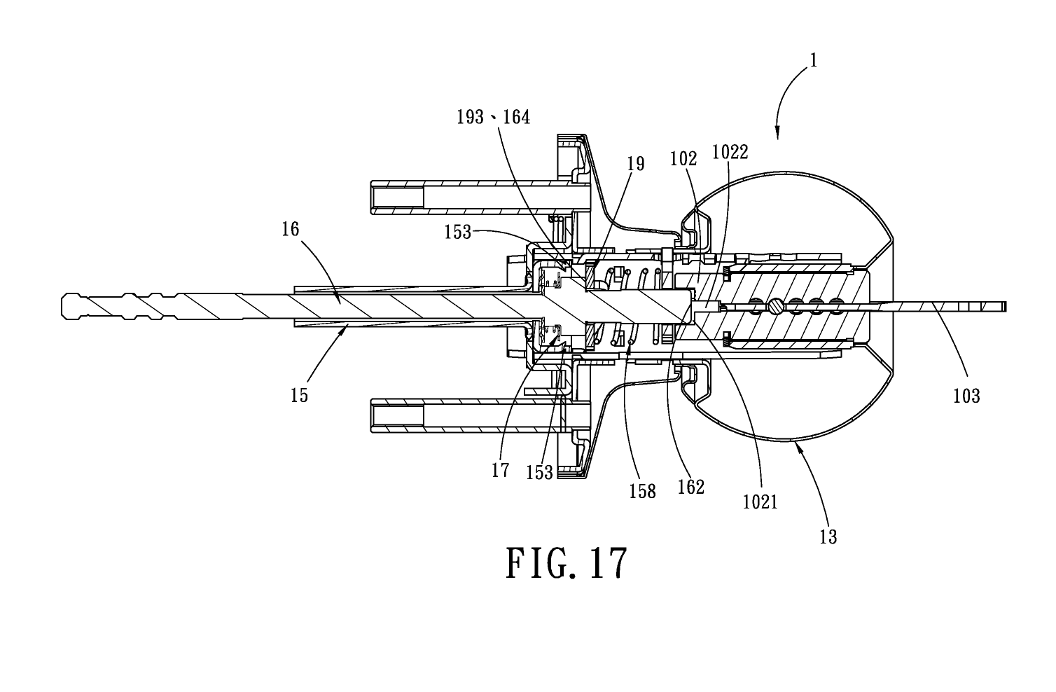

Referring to FIGS. 1-11, 16 and 17, the cylinder lock assembly may also be placed in its locked state by rotating the operator 21 of the inner lock unit 2 or by operating the key 103. When the operator 21 is rotated for locking the cylinder lock assembly, the spindle 16 is brought by the operator 21 to rotate to the first locked state. When the key 103 is rotated to turn the plug 101 for locking the cylinder lock assembly, the push edges 1023 of the wide coupling slot 1021 drive rotation of the spindle 16 to the first locked state. In either case, the lugs 164 of the spindle 16 slide from the deep surfaces 194 (see FIGS. 10, 11) to the shallow surfaces 193 (see FIGS. 16, 17) through the slanting surfaces 195 so that the cam member 19 moves axially towards the rose disc 11, and the locking tongues 192 move from their position shown in FIGS. 10 and 11 to their position shown in FIGS. 16 and 17, where the locking tongues 192 engage the respective retaining recesses 112. Because the locking tongues 192 extend into the respective apertures 123 and the respective retaining recesses, the outer drive tube 12 is prevented from rotating relative to the rose disc 11. As a result, the outer handle 13 and the latch operating tube 15 are locked against rotational movements placing the cylinder lock assembly in a locked state.

When the operator 21 is rotated in a reverse direction to turn the spindle 16, or when the key 103 is rotated in a reverse direction to turn the plug 101 and to cause the push edges 1023 of the wide coupling slot 1021 to push and turn the spindle 16, the lugs 164 slide to the deep surfaces 194 (see FIGS. 10, 11) from the shallow surfaces 193 (see FIGS. 16, 17) through the slanting surfaces 195 so that the cam member 19 moves axially away from the rose disc 11, and the locking tongues 192 move away from the retaining recesses 112 and from their positions shown in FIGS. 16, 17 to their positions shown in FIGS. 10, 11, where the locking tongues 192 return to the respective notches 155. At this state, the outer handle 13 can be rotated to turn the outer drive tube 12 relative to the rose disc 11 and to unlock the cylinder lock assembly. In addition, continued rotation of the key 103 will cause the spindle 16 to push the cam member 19 so that the locking tongues 192 drive rotation of the latch operating tube 15, which results in retraction of the latch member 31.

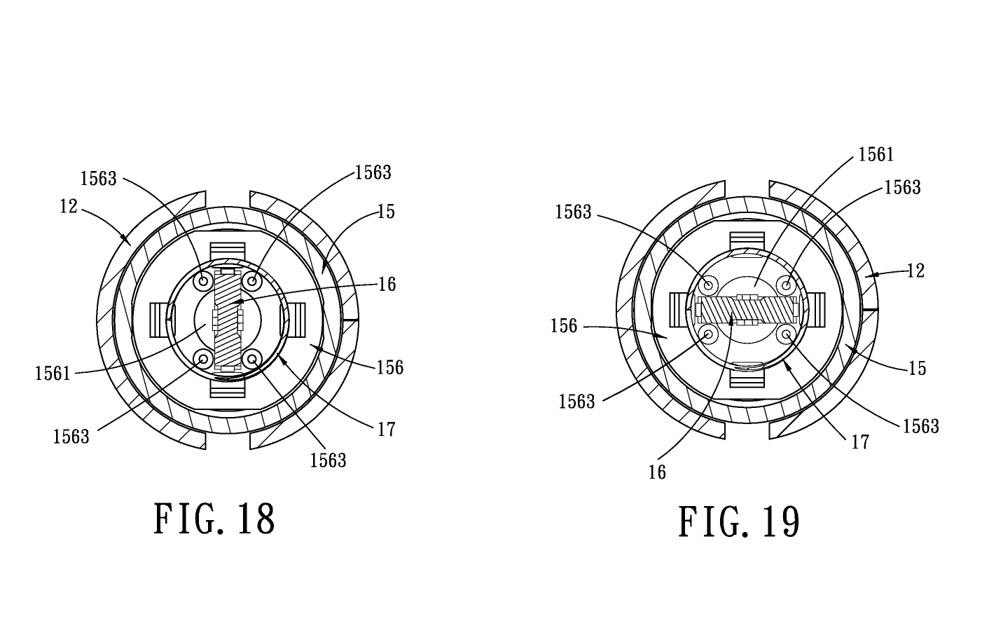

Referring to FIGS. 1-11, 16-19, when the inner handle 22 is rotated for unlocking the cylinder lock assembly, the latch operating tube 15 will bring the unlocking plate 156 to rotate, and the studs 1563 of the unlocking plate 156 will push the ear members 165 of the spindle 16, thereby driving rotation of the spindle 16. As a result, the lugs 164 will slide from the shallow surfaces 193 of the cam member 19 (FIGS. 16 & 17) to the deep surfaces 194 (FIGS. 10 & 11) so that the cam member 19 is moved away from the rose disc 11 by the action of the first spring 158 and the locking tongues 192 are moved away from the respective retaining recess 112 and from the position shown in FIGS. 16 & 17 to the peripheral edge of the enlarged end portion 152 of the latch operating tube 15. When the inner handle 22 is returned to its home position by the torsional returning mechanism (not shown) of the inner lock unit 2, the locking tongues 192 return to the respective notches 155 of the latch operating tube 15.

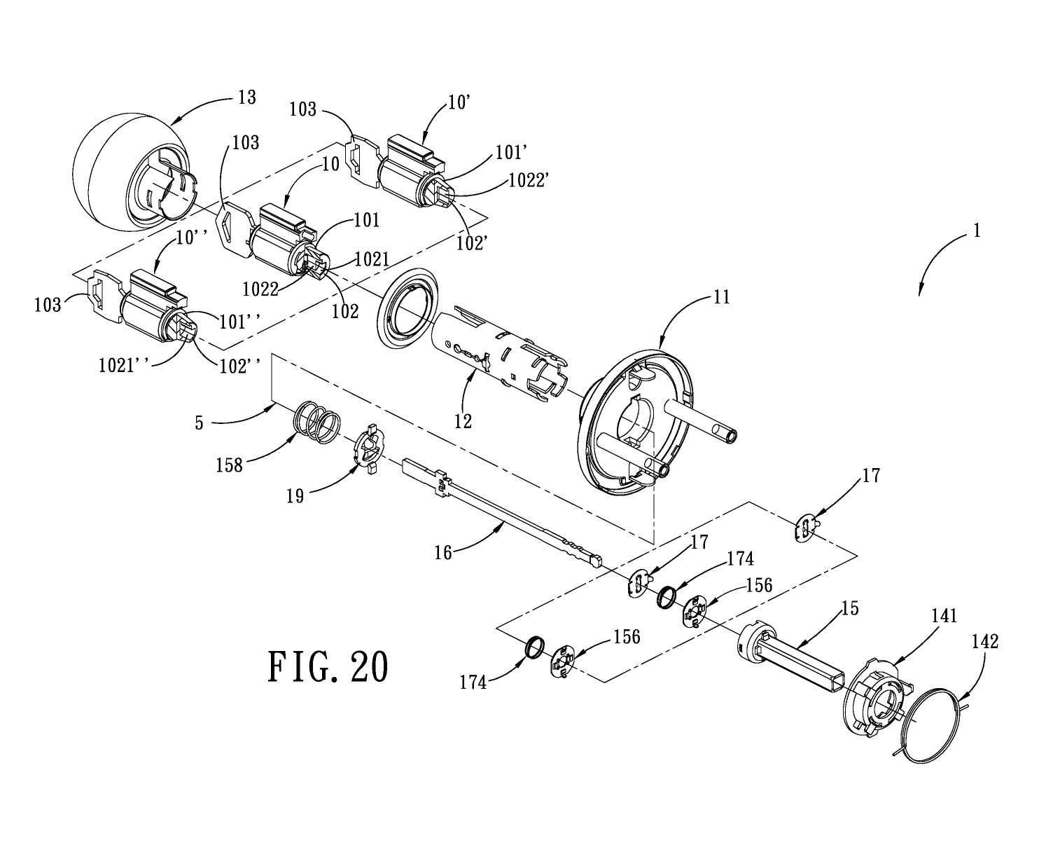

Referring to FIG. 20, the key-operated lock 10 of the cylinder lock assembly may be replaced by a key-operated lock 10′ according to a second preferred embodiment of the present invention, or a key-operated lock 10″ according to a third preferred embodiment of the present invention.

According to the second preferred embodiment, the key-operated lock 10′ differs from the key-operated lock 10 in that the coupler 102′ thereof has only the narrow coupling slot 1022′ which is rectangular. The second spring 174 and the unlocking plate 156 are not needed when the key-operated 10′ is used. When the operator 21 is pressed, the spindle 16 is moved to its second locked state (FIGS. 12, 13) from its unlocked state (FIGS. 10, 11) thereby placing the cylinder lock assembly in the locked state. The cylinder lock assembly may be placed in its unlocked state by rotating the inner handle 22 or by operating the key 103. However, unlike the first preferred embodiment, the cylinder lock assembly in the second embodiment cannot be locked by operating the key 103.

According to the third preferred embodiment, the key-operated lock 10″ differs from the key-operated lock 10 in that the coupler 102″ thereof has only the wide coupling slot 1021″ whose shape is similar to a figure eight-shape. The locking plate 17 is not needed when the key-operated lock 10″ is used. The cylinder lock assembly may be placed in its locked state by rotating the operator 21 to move the spindle 16 to the first locked state (FIGS. 16, 17) from the unlocked state (FIGS. 10, 11). When the inner handle 22 or the key 103 is rotated in the third embodiment, the cylinder lock assembly is placed in its state. Like the first preferred embodiment, the cylinder lock assembly in the third embodiment can be locked or unlocked by rotating the key 103 or the operator 21. However, the operator 21 in the third embodiment is not pressable.

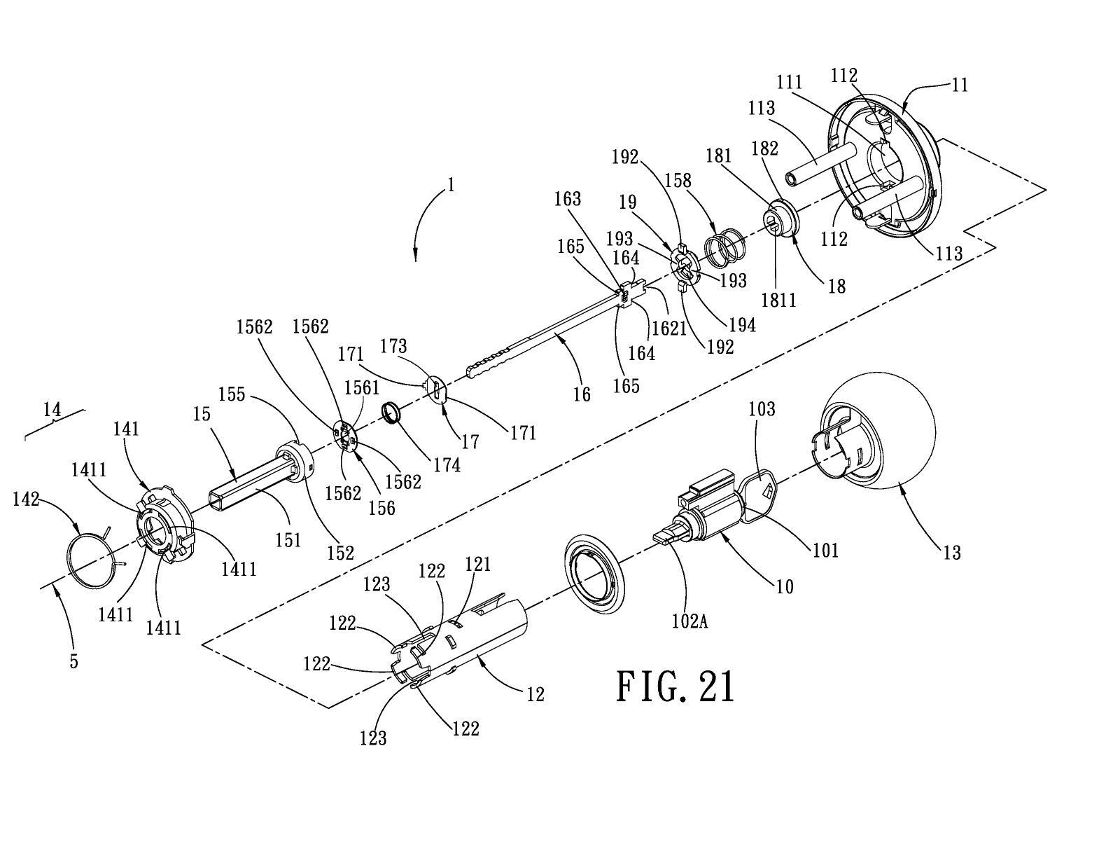

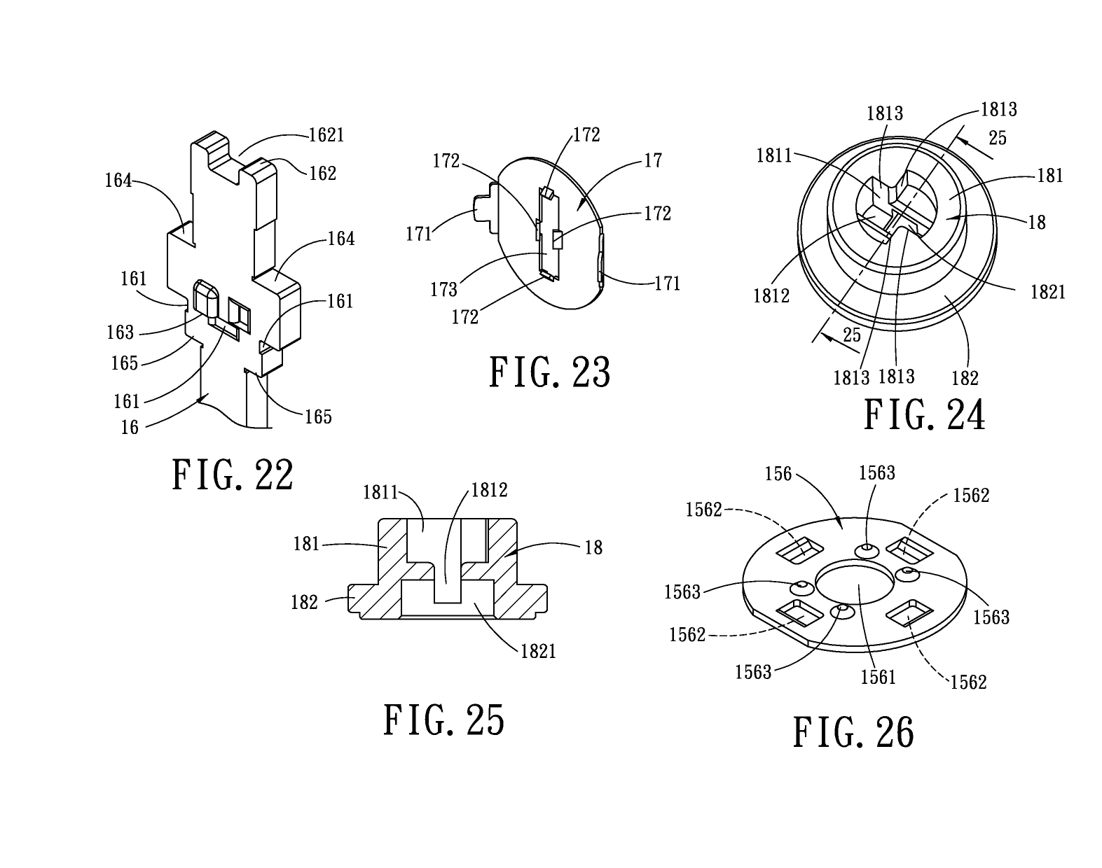

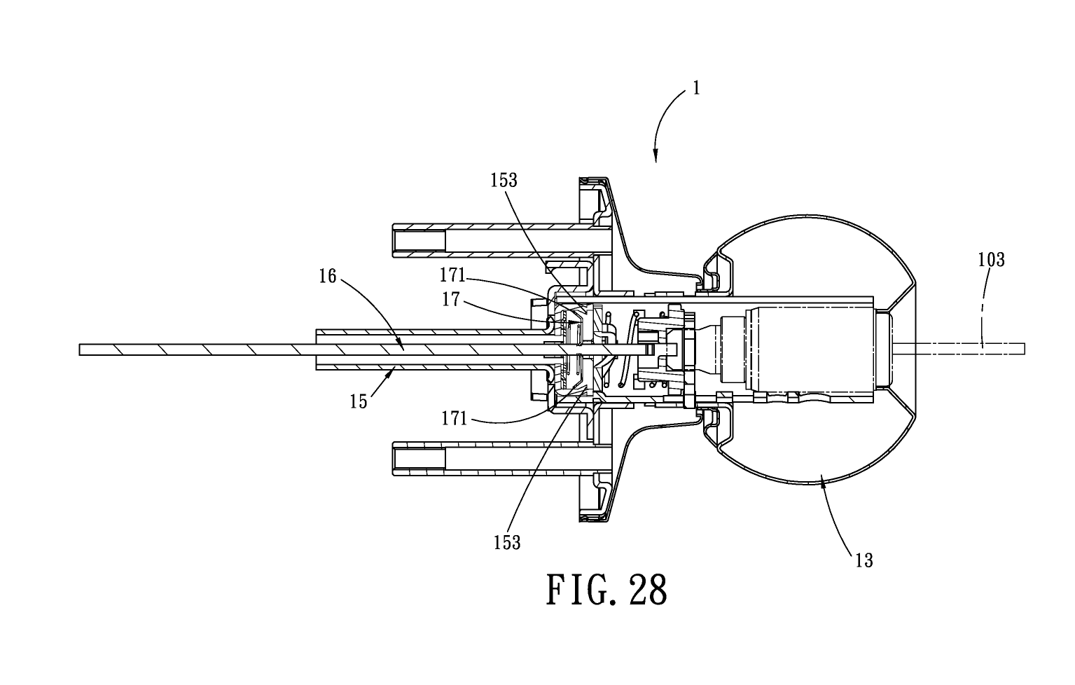

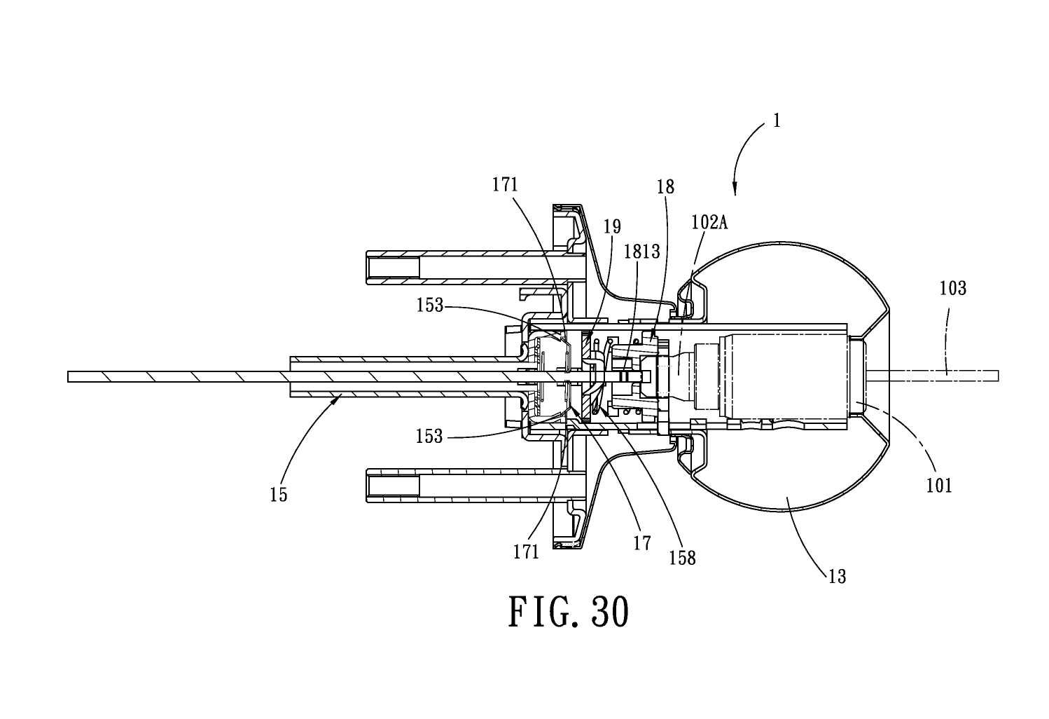

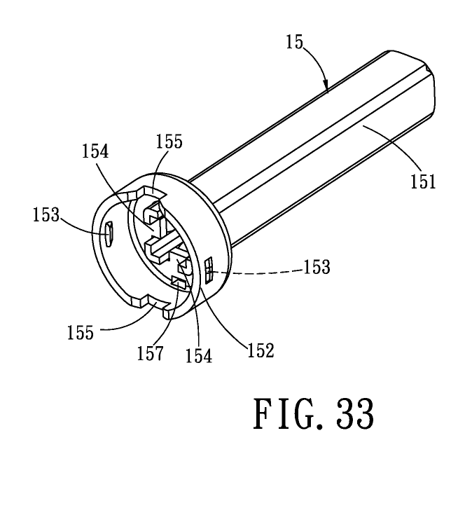

Referring to FIGS. 21 to 33, a fourth preferred embodiment of the present invention is substantially similar to the first preferred embodiment. However, the key-operated lock 10 in this embodiment has a connecting plate 102A at its tail end, and a separate coupler 13 is connected to the connecting plate 102A as shown in FIG. 21. The latch operating tube 15 in this embodiment does not have the holes 157 of the latch operating tube 15 in the first preferred embodiment as shown in FIGS. 3 and 33. The unlocking plate 156 in this embodiment is not provided with the prongs 1564 of the unlocking plate 156 of the first preferred embodiment as shown in FIGS. 9 and 26. The locking plate 17 in this embodiment is slightly different from the locking plate 17 of the first embodiment as shown in FIGS. 5 and 23. The terminating end 162 of the spindle 16 in this embodiment is formed with an additional end notch 1621 as shown in FIG. 22.

Referring to FIGS. 21, 24 and 25, the coupler 18 is a substantially cylindrical stepped body disposed inside the outer drive tube 12, and includes a small section 181 that is formed with a wide coupling slot (figure eight-shaped slot) 1811, and a narrow coupling slot (narrow rectangular slot) 1812, and a large section 182 that is formed with a plate-shaped slot 1821. The wide coupling slot 1811 is communicated with the narrow coupling slot 1812. The narrow coupling slot 1812 intersects the plate-shaped slot 1821 substantially perpendicularly. Four push edges 1813 are formed around the wide coupling slot 1811. The plate-shaped slot 1821 is used to insert the connecting plate 102A of the plug 101. The large section 182 is disposed in abutment with the retention member 121 of the outer drive tube 12 and the inner surface of the outer drive tube.

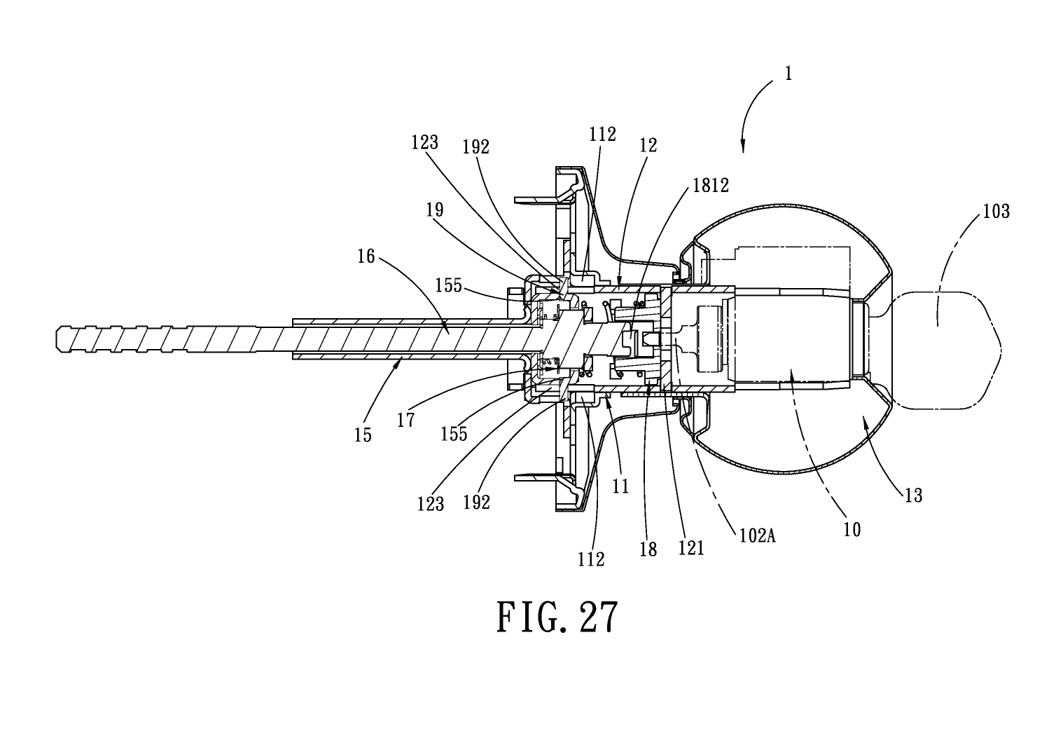

Referring to FIGS. 21 and 27, the first spring 158 is disposed between the cam member 19 and the coupler 18. One end of the first spring 158 is retained on the cam member 19. Another end of the first spring 158 is sleeved around the small section 181 of the coupler 18 and is retained on the large section 182, thereby biasing the cam member 19.

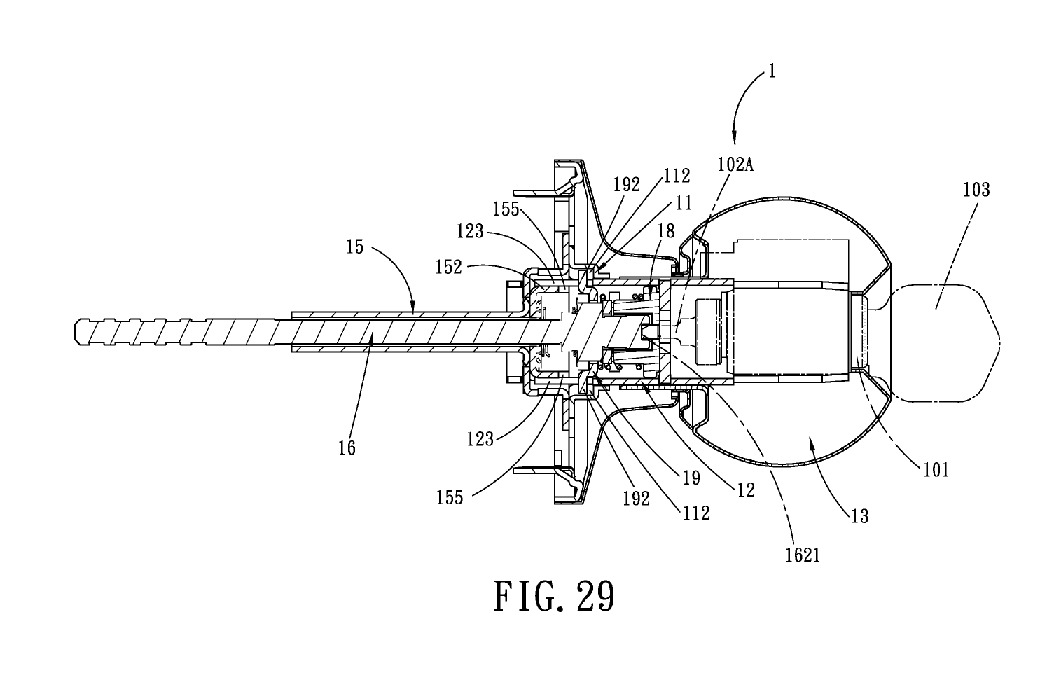

Referring to FIGS. 21, 27 and 28, when the spindle 16 is its unlocked state, the terminating end 162 of the spindle 16 formed with the end notch 1621 is inserted into the wide coupling slot 1811 of the coupler 18. When the spindle 16 is pressed to be in the second locked state as shown in FIGS. 29 & 30, the end notch 1621 of the spindle 16 extends into the narrow coupling slot 1812 and engages the connecting plate 102A of the key-operated lock 10 so that, when the coupler 18 is rotated by the connecting end 102A, the spindle 16 is also rotated.

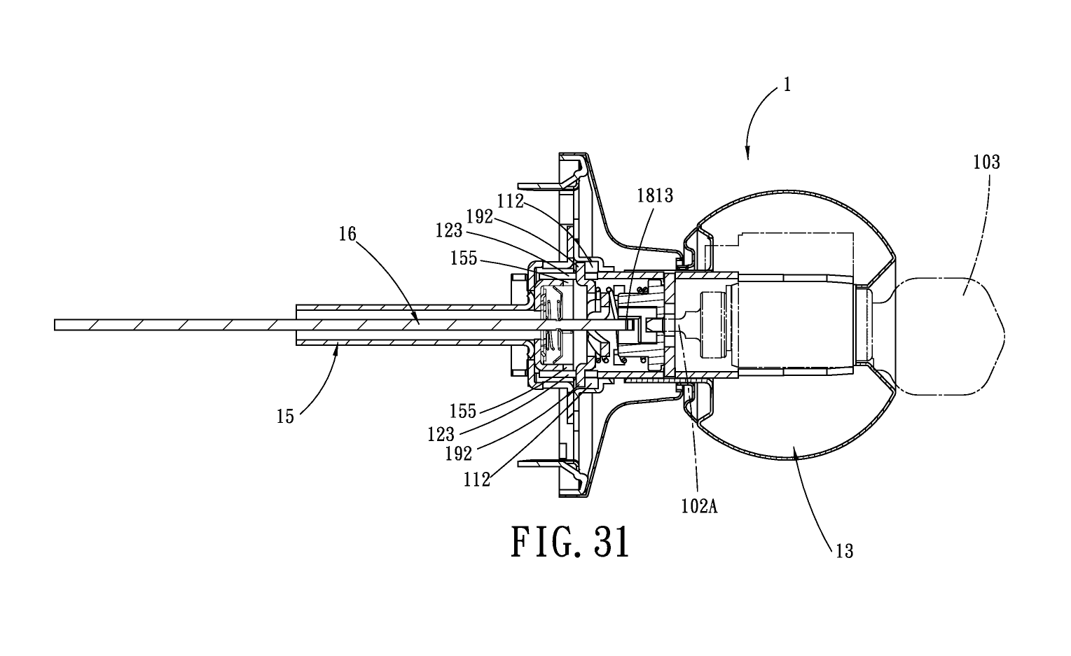

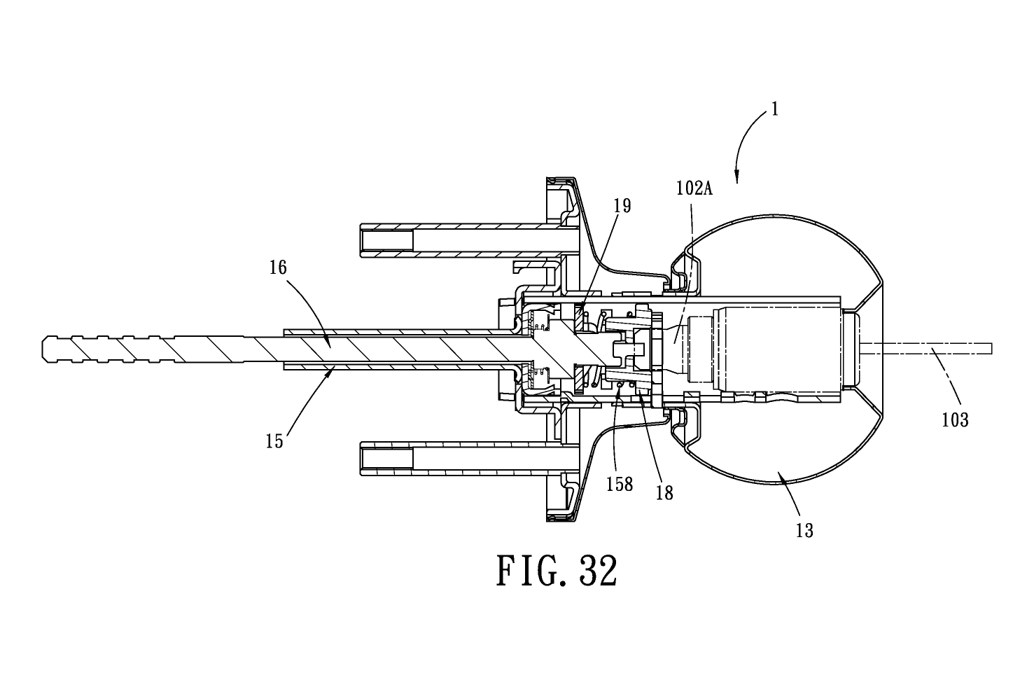

When the operator 21 is rotated or the key 103 is rotated to turn the plug 101 for an unlocking operation, because the terminating end 162 is in the wide coupling slot 1811, the push edges 1813 of the wide coupling slot 1811 can push the spindle 16 so that the spindle 16 can be rotated to the first locked state as shown in FIGS. 31 and 32.

While the present invention has been described in connection with what is considered the most practical and preferred embodiments, it is understood that this invention is not limited to the disclosed embodiment but is intended to cover various arrangements included within the spirit and scope of the broadest interpretation so as to encompass all such modifications and equivalent arrangements.

What is claimed is:

1. A cylinder lock assembly comprising:
a latch unit;
an outer handle;
an outer drive tube connected to said outer handle;
a latch operating tube connected to said latch unit, and having an enlarged end portion extending into said outer drive tube oppositely of said outer handle;
a spindle extending axially through said latch operating tube, and having an end portion that extends through said enlarged end portion, said spindle being rotatable from an unlocked state to a first locked state, and being movable axially from said unlocked state to a second locked state;
a drive tube-retainer to prevent said outer drive tube from rotating when said spindle is in said first or second locked state;
a key-operated lock that is connected to said end portion of said spindle and that is rotatable to move said spindle to said first lock state from said unlocked state; and
an inner lock unit including an operator that is connected to another end portion of said spindle and that is pressable to move said spindle to said second locked state from said unlocked state.

2. The cylinder lock assembly of claim 1, further comprising a rose disc that has a retaining recess, said outer drive tube having an axially extending aperture, said drive tube-retainer including a cam member that is disposed around said end portion of said spindle and that includes a locking tongue projecting radially and outwardly from an outer periphery of said cam member to extend through said aperture of said outer drive tube, said spindle further having a lug projecting radially and outwardly from said end portion to actuate said cam member and to move said locking tongue along said aperture and into or out of said retaining recess when said spindle is moved between said unlocked state and said first locked state or between said unlocked state and said second locked state.

3. The cylinder lock assembly of claim 2, wherein said cam member further includes a cam face that has a shallow surface, a deep surface and a slanting surface extending between said shallow and deep surfaces and that is in contact with said lug, and wherein, when said spindle is rotated to move between said unlocked state and said first locked state, said lug rotates slidingly over said shallow and deep surfaces and said slanting surface, resulting in a movement of said locking tongue along said aperture and toward or away from said retaining recess.

4. The cylinder lock assembly of claim 2, further comprising an unlocking member fixed to said latch operating tube within said enlarged end portion and engaging said end portion of said spindle, said spindle being driven by said unlocking member to rotate from said first locked state to said unlocked state when said latch operating tube rotates.

5. The cylinder lock assembly of claim 4, wherein said latch operating tube further has a rectangular tube and a shoulder portion between said rectangular tube and said enlarged end portion, said unlocking member being disposed on said shoulder portion and within said enlarged end portion.

6. The cylinder lock assembly of claim 5, wherein said unlocking member has an unlocking plate disposed around said spindle, fixed to said shoulder portion within said enlarged end portion, and having an engagement surface protruding axially of said spindle and engaging said spindle.

7. The cylinder lock assembly of claim 6, wherein said end portion of said spindle has an ear member projecting radially therefrom and abutting against said unlocking plate, said engagement surface having spaced apart studs projecting axially of said spindle and engaging said ear member.

8. The cylinder lock assembly of claim 1, further comprising a locking plate that is fixed around said end portion of said spindle within said enlarged end portion and that has a locking part projecting radially and outwardly, said enlarged end portion of said latch operating tube having a protrusion projecting radially and inwardly from an inner wall surface of said enlarged end portion to engage said locking part when said spindle is pressed to move axially to said second locked state.

9. The cylinder lock assembly of claim 1, wherein said key-operated lock has a rotatable plug, and a coupler connected to said plug, said coupler having wide and narrow coupling slots that are aligned and intercommunicated axially, said end portion of said spindle having a terminating end, said terminating end being inserted into said wide coupling slot when said spindle is in said unlocked state and said first locked state and extending into said narrow coupling slot when said spindle is pressed to said second locked state.

10. A cylinder lock assembly comprising:
a latch unit;
a rose disc having a retaining recess;
an outer handle;
an outer drive tube connected to said outer handle inside said rose disc and having an axially extending aperture;
a latch operating tube connected to said latch unit, and having an enlarged end portion extending into said outer drive tube oppositely of said outer handle;
a spindle extending axially through said latch operating tube, and having an end portion that extends through said enlarged end portion, said spindle being movable between a locked state and an unlocked state;
an unlocking member connected to said enlarged end portion of said latch operating tube and engaging said end portion of said spindle, said spindle being driven by said unlocking member to rotate from said locked state to said unlocked state when said latch operating tube rotates; and
an inner lock unit including an operator that is connected to another end portion of said spindle, and that is operable to move said spindle to said locked state from said unlocked state.

11. The cylinder lock assembly of claim 10, wherein said latch operating tube further has a rectangular tube and a shoulder portion between said rectangular tube and said enlarged end portion, said unlocking member being disposed on said shoulder portion and within said enlarged end portion.

12. The cylinder lock assembly of claim 11, wherein said unlocking member has an unlocking plate disposed around said spindle, connected to said shoulder portion within said enlarged end portion, and having an engagement surface protruding axially of said spindle and engaging said spindle.

13. The cylinder lock assembly of claim 12, wherein said end portion of said spindle has an ear member projecting radially therefrom and abutting against said unlocking plate, said engagement surface having spaced apart studs projecting axially of said spindle and engaging said ear member.

14. The cylinder lock assembly of claim 10, further comprising a cam member that is disposed around said end portion of said spindle and that includes a locking tongue projecting radially and outwardly from an outer periphery of said cam member to extend through said aperture of said outer drive tube, said spindle having a lug that projects radially and outwardly from said end portion to abut against a cam face of said cam member, said locking tongue being movable axially along said aperture to engage or disengage said retaining recess when said spindle is rotated to actuate said lug to move slidingly over said cam face, said locking tongue engaging said retaining recess when said spindle is rotated from an unlocked state to a first locked state.

15. The cylinder lock assembly of claim 14, wherein said cam face has a shallow surface, a deep surface and a slanting surface extending between said shallow and deep surfaces, and wherein, when said spindle is rotated between said unlocked state and said locked state, said lug moves slidingly over said shallow and deep surfaces and said slanting surface, resulting in a movement of said locking tongue along said aperture and toward or away from said retaining recess.

16. The cylinder lock assembly of claim 15, further comprising a retention member disposed transversely inside said outer drive tube and engaging said outer handle, and a first spring disposed between said retention member and said cam member.

17. The cylinder lock assembly of claim 16, wherein said end portion of said spindle has a terminating end extending outwardly of said enlarged end portion, said cam member being disposed around said end portion between said terminating end and said lug and being biased by said first spring to place said locking tongue to abut against a peripheral edge of said enlarged end portion and to place said cam face in contact with said lug.

18. A cylinder lock assembly comprising:
a latch unit;
a rose disc having a retaining recess:
an outer handle;
an outer drive tube connected to said outer handle inside said rose disc and having an axially extending aperture;
a latch operating tube connected to said latch unit, and having an enlarged end portion extending into said outer drive tube oppositely of said outer handle;
a spindle extending axially through said latch operating tube, and having an end portion that extends through said enlarged end portion, and a lug projecting radially and outwardly from said end portion, said spindle being rotatable from an unlocked state to a first locked state, and being movable axially from said unlocked state to a second locked state;
a cam member that is disposed around said end portion of said spindle and that includes a cam face to abut against said lug of said spindle, and a locking tongue projecting radially and outwardly from an outer periphery of said cam member to extend through said aperture of said outer drive tube, said cam face having a shallow surface, a deep surface and a slanting surface extending between said shallow and deep surfaces;
a key-operated lock having a rotatable plug, and a coupler connected to said plug, said coupler having wide and narrow coupling slots that are aligned and intercommunicated axially, said end portion of said spindle having a terminating end, said terminating end being inserted into said wide coupling slot when said spindle is in said unlocked state and said first locked state and extending through said wide coupling slot and into said narrow coupling slot when said spindle is pressed to said second locked state; and
an inner lock unit including an operator that is connected to another end portion of said spindle and that is pressable to move said spindle to said second locked state from said unlocked state;
said locking tongue being movable axially along said aperture to engage or disengage said retaining recess when said spindle is moved to actuate said lug to move said cam face, said locking tongue engaging said retaining recess when said spindle is moved from said unlocked state to said second locked state;

19. The cylinder lock assembly of claim 18, wherein said unlocking member has an unlocking plate disposed around said spindle, connected to said enlarged end portion, and having an engagement surface protruding axially of said spindle, said end portion of said spindle having an ear member projecting radially therefrom and aligned axially with said lug member to abut against said engagement surface.
